(19) United States
(12) Patent Application Publication
(10) Pub. No.: US 2010/0299840 A1
(43) Pub. Date: Dec. 2, 2010

(54) WEIGHT AND/OR MOVEMENT SENSING IN A BED

(75) Inventors: Andreas Brauers, Aachen (DE); Ralf Dorscheid, Kerkrade (NL); Frank Johnen, Juelich-koslar (DE)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N.V., EINDHOVEN (NL)

(21) Appl. No.: 12/599,068

(22) PCT Filed: May 7, 2008
(86) PCT No.: PCT/IB2008/051790

§ 371 Date: Nov. 6, 2009

(30) Foreign Application Priority Data
May 14, 2007 (EP) 07108179.8

(51) Int. Cl. G01G 19/52

(52) U.S. Cl. 5/658; 177/144; 177/1

(57) ABSTRACT

The invention refers to a sensor arrangement for weight and/or movement sensing in a bed and uses thereof, to a bed and to a method of sensing weight and/or movement of a user in a bed. For the sensing of weight, activity and/or cardiopulmonary performance in a bed, force sensors (6) integrated between a bedframe (2) and a mattress frame (3) are used. The sensors are designed in a way that they can be positioned between the mattress frame and the bedframe without significantly enhancing the height of a mattress bearing surface. Thus, the integration into any bed with bedframe can be easily realized. The measurements do not require any user interaction or even direct contact between user and sensor.

The invention refers to a sensor arrangement for weight and/or movement sensing in a bed and uses thereof, to a bed and to a method of sensing weight and/or movement of a user in a bed.

The measurement of vital body signs in bed using force or pressure sensors is known. One of the very important parameters that can be measured in bed is the weight of the person. This is especially interesting for patients with a cardiac disease or other patients which are bed ridden. Integrating standard weight sensors into the bed usually means introducing mechanical springs between the subject bearing surface and the ground and measuring their deformation, for example by strain gauges. In the U.S. Pat. No. 4,793,428, a hospital bed with an integrated scale is disclosed which is incorporated into the bed between the bed support frame and the patient support section. For reasons of mechanical stability, measuring the weight of a human body, mechanical setups which are at least a couple of centimeter in height, are required. It is a drawback that the height of the scale leads to an elevation of parts of the bed. While in a professional environment (hospital, nursing homes, . . . ) this can be accepted and also compensated to some extent due to the standardized nature of the beds. However, this is a real issue, when an application in the patients' homes is addressed. Here, the sensors should be integratable into the bed of the patient, without compromising the comfort of the patient, and virtually invisible, thus not disturbing the design of the bed. This aim should be achieved irrespective of the specific design of the patient's bed.

It is therefore an objective of the present invention to provide a sensor arrangement for weight and/or movement sensing in a bed, which reduces the drawbacks according to the state of the art.

The above objective is accomplished by a sensor arrangement for weight and/or movement sensing in a bed, comprising a structure attachable between a bedframe and a mattress frame, the structure comprising a first sensor support and a second sensor support, the first sensor support and the second sensor support extending in a space below the mattress frame, where in the space the mattress frame is unsupported by the bedframe, wherein at least one sensor is arranged between the first sensor support and the second sensor support. While this invention is focused on retrofit solutions for standard beds in patients' homes it can also be adapted to the needs of hospital and care beds.

It is an advantage of the sensor arrangement according to the invention, that it can be attached to a bed without significantly enhancing a height of a surface bearing the structure, i.e. the bedframe. Thus the height of the mattress frame above the bedframe is only marginally increased. Nevertheless, the sensor arrangement provides advantageously the mandatory stiffness of a spring, allowing for a quantitative force measurement like weight measurement in the bed. It is a further advantage that no constructive changes to the bed itself are necessary.

The bedframe of the bed is a structural part which has substantially direct and unsprung contact to the ground, i.e. there are essentially no elastic elements between the bedframe and the ground. The bedframe is thus advantageously applicable to accommodate the sensor support. The mattress frame of the bed is, according to the sense of the invention, the frame which is usually supported by the bedframe in any regular bed. The mattress frame carries directly or indirectly the mattress. Preferably, the mattress frame is a slatted frame, but may as well be a frame with a network of springs or even a flat plank. The bedframe usually supports the mattress frame in an edging area or, as the case may be, additionally in an area of a crossbeam. The space below the mattress frame, in which the mattress frame is unsupported by the bedframe, in the sense of the invention, is that space, which is enclosed by a vertical projection of the bedframe or, respectively, the of the supporting area of the bedframe and the mattress frame. This space below the mattress frame is advantageously applicable for measuring the weight and/or vital body signs (VBS). In particular, mechanical setups for measuring the weight of a human body, are advantageously easily accommodated in the unutilized space between the mattress frame and the ground. As a further advantage, the sensors and the sensor supports are located in a hidden position below the bed, the design of which is thus unaffected by the sensor arrangement. The structure, the first sensor support and the second sensor support are any kind of essentially rigid beams which are applicable for carrying the sensor. Preferably, the sensor is a force detecting sensor.

According to a preferred embodiment of the invention, the structure comprises load transmission means for transmitting forces exerted between the mattress frame and the bedframe to the first sensor support and the second sensor support. The structure advantageously only marginally increases the height of the mattress frame above the bedframe. Preferably a dimension of the structure between the bedframe and the mattress frame is substantially smaller than a distance between the first sensor support and the second sensor support. The distance between the first sensor support and the second sensor support is the space which is advantageously utilizable for accommodating the sensor.

According to another preferred embodiment of the invention, the first sensor support is pivotally connected to the second sensor support. The structure comprises in particular a scissor-like mechanism. This embodiment of the structure is particularly advantageous for accommodating one sensor. Preferably, a plurality of sensor arrangements according to this embodiment is attached between the bedframe and the mattress frame.

According to a further preferred embodiment of the invention, the first sensor support and/or the second sensor support is formed as an intermediate frame. The intermediate frames extend across the bed like a longitudinal beam or cross beam between the parts of the bedframe. Preferably, a plurality of sensors is arranged between the first sensor support and the second sensor support.

Another object of the invention is a bed for sensing weight and/or movement of a user, comprising a bedframe and a mattress frame, wherein at least one sensor arrangement according to the invention as described in here before, is attached between the bedframe and the mattress frame. It is an advantage that any suitable standard bed which comprises a bedframe and a preferably detachable mattress frame, is easily equipped with the sensor arrangement. The bed is preferably only temporarily equipped with the sensor arrangement.

In a preferred embodiment of the invention, the bed is retrofit with the sensor arrangement. The integration of the sensor arrangement into the bed may advantageously be done as a retrofit by laymen or service persons with minimum effort and in a very easy procedure.

A further object of the invention is a method of sensing weight and/or movement of a user in a bed, comprising the steps of

transferring forces exerted between a bedframe and a mattress frame of the bed to a space below the mattress frame, where in the space, the mattress frame is unsupported by the bedframe and

measuring the forces by at least one sensor in the space below the mattress frame.

The space below the mattress frame, in which the mattress frame is unsupported by the bedframe, is advantageously applicable for measuring the weight and/or vital body signs.

For the sensing of weight and/or movement, including activity and/or cardiopulmonary performance in a bed, preferably force sensors integrated between the bedframe and the mattress frame are used. The sensors are designed in a way that they can be positioned between the mattress frame and the bedframe without significantly enhancing the height of a mattress bearing surface. Thus, the integration into any bed with bedframe can be easily realized. The measurements do not require any user interaction or even direct contact between user and sensor.

A further object of the invention is a use of a sensor arrangement according to the invention for sensing a weight and/or movements of a user in a bed.

A further object of the invention is a use of a sensor arrangement according to the invention for equipping a bed comprising a bedframe and a mattress frame with a weight and/or movement sensing feature.

These and other characteristics, features and advantages of the present invention will become apparent from the following detailed description, taken in conjunction with the accompanying drawings, which illustrate, by way of example, the principles of the invention. The description is given for the sake of example only, without limiting the scope of the invention.

The reference Figures quoted below refer to the attached drawings.

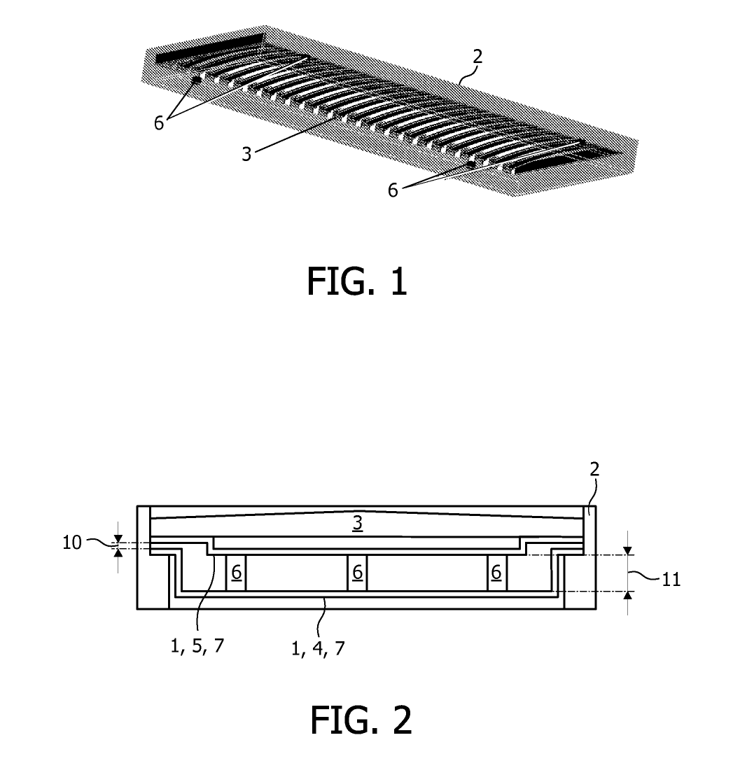

FIG. 1 illustrates schematically a sensor arrangement and a bed according to the invention.

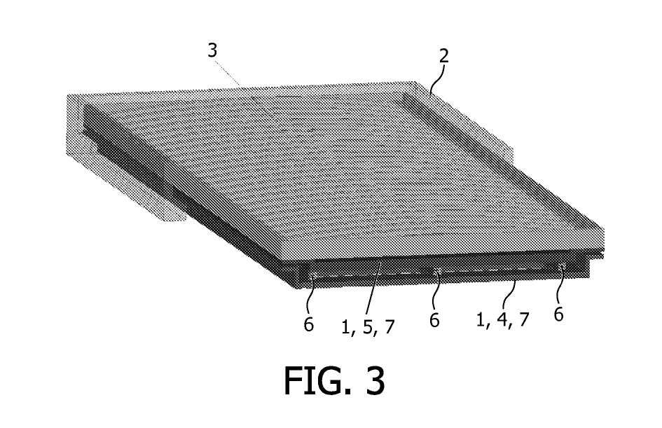

FIGS. 2 and 3 illustrate schematically a first embodiment of the sensor arrangement according to the invention in two views.

FIG. 3 illustrates schematically a second embodiment of the sensor arrangement according to the invention.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the present description and claims, should not be interpreted as being restricted to the means listed thereafter; it does not exclude other elements or steps. Thus, the scope of the expression “a device comprising means A and B” should not be limited to devices consisting only of components A and B. It means that with respect to the present invention, the only relevant components of the device are A and B.

FIG. 1 shows a schematic perspective view of a bed according to the invention comprising a sensor arrangement according to the invention. Parts of a bedframe 2 are cut away. FIG. 1 illustrates the positions of sensors 6 and the principle of operation of the invention. While a user (not depicted) is lying on the bed, his movements are transferred to a mattress (not shown) and a mattress frame 3 which is a slatted frame 3 in the depicted embodiment. The movements are transferred from the slatted frame 3 to the bedframe 2 which is in contact to the ground, for example by means of legs (not depicted). Even small movements can be detected using appropriately sensitive force sensors 6. The majority of beds used in private homes are equipped with slatted frames or also metal frames or can easily and at low cost be equipped with slatted frames. These mattress frames 3 usually lie on a supporting surface of the bedframe 2. The same principle of working may as well be applied to a bed where the mattress is directly lying on the bedframe 2.

Between the supporting surface of the bedframe 2 and the mattress frame 3, sensors 6 are located, preferably integrated, which carry the weight of the mattress frame 3, the mattress and the user and can be used for weight sensing and measuring of VBS like heart rate, breathing rate and activity. In order, not to enhance the height of the setup by introducing the sensors 6, the force acting on the sensors 6 is diverted to a space below the mattress frame 3, where in this space, the mattress frame 3 is unsupported by the bedframe 2, i.e. to a space, which is not located between the slatted frame 3 and bedframe 2. This is achieved by using a structure (see FIG. 2) for direct mechanical coupling or by using an appropriate hinge mechanism.

In FIGS. 2 and 3, a schematic side view and a schematic perspective view of an embodiment according to the invention are depicted. The structure 1 comprises a first sensor support 4 and a second sensor support 5, the sensors 6 being arranged between the first and second sensor support 4, 5. The first sensor support 4 is carried by the bedframe 2. The second sensor support 5 is carried via the sensors 6 by the first sensor support 4 and the mattress frame 3 is carried by the second sensor support 5. In this embodiment the first and second sensor support 4, 5 of structure 1 are formed as intermediate frames 7, spanning from one side of the bedframe 2 to the other. In FIG. 2, a dimension 10 of the structure 1 between the bedframe 2 and the mattress frame 3 is depicted, which is substantially smaller than a distance 11 between the first sensor support 4 and the second sensor support 5. Thus the unutilized space below the mattress frame 3 is advantageously used for arranging the sensors 6.

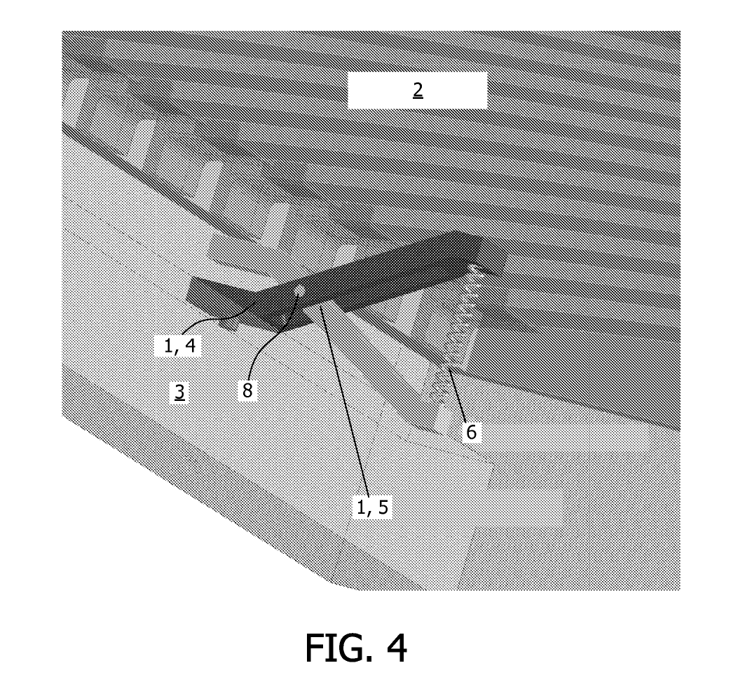

As can be seen from FIG. 4, a perspective close-up perspective view of a sensor arrangement according to another embodiment is depicted, wherein instead of using an intermediate frame (FIGS. 2 and 3), the sensors 6 can be directly inserted in a similar scheme but as a single device. This embodiment of the sensor arrangement may be equipped in three, preferably four positions along the sides of the bedframe 2. The diversion of the force can be done directly using a structure 1 as for the intermediate frame (FIG. 2) or using a hinge mechanism. Here, the first sensor support 4 and the second sensor support 5 are pivotally connected via pivot pin 8, thus forming a scissor-like mechanism.

The space in which the first sensor support 4 and the second sensor support 5 according to the invention extend, is enclosed by the mattress frame 3 from above, by vertical projections of the supporting surfaces of the bedframe 2 from the sides, and by the ground from below.

1. Sensor arrangement for weight and/or movement sensing in a bed, comprising a structure (1) attachable between a bedframe (2) and a mattress frame (3), the structure comprising a first sensor support (4) and a second sensor support (5), the first sensor support and the second sensor support extending in a space below the mattress frame (3), where in the space, the mattress frame is unsupported by the bedframe (2), and wherein at least one sensor (6) is arranged between the first sensor support (4) and the second sensor support (5).

2. Sensor arrangement according to claim 1, wherein the structure comprises load transmission means for transmitting forces exerted between the mattress frame (3) and the bedframe (2) to the first sensor support (4) and the second sensor support (5).

3. Sensor arrangement according to claim 1, wherein a dimension (10) of the structure (1) between the bedframe (2) and the mattress frame (3) is substantially smaller than a distance (11) between the first sensor support (4) and the second sensor support (5).

4. Sensor arrangement according to claim 1, wherein the first sensor support (4) is pivotally connected to the second sensor support (5).

5. Sensor arrangement according to claim 1, wherein the first sensor support (4) and/or the second sensor support (5) is formed as an intermediate frame (7).

6. Sensor arrangement according to claim 1, wherein a plurality of sensors (6) is arranged between the first sensor support (4) and the second sensor support (5).

7. Sensor arrangement according to claim 1, wherein the sensor (6) is a force detecting sensor.

8. Bed for sensing weight and/or movement of a user, comprising a bedframe (2) and a mattress frame (3), wherein at least one sensor arrangement according to claim 1 is attached between the bedframe and the mattress frame.

9. Bed according to claim 8, wherein the bed is retrofit with the sensor arrangement.

10. Method of sensing weight and/or movement of a user in a bed, comprising the steps of
transferring forces exerted between a bedframe (2) and a mattress frame (3) of the bed to a space below the mattress frame, where in the space, the mattress frame is unsupported by the bedframe and
measuring the forces by at least one sensor in the space below the mattress frame.

11. (canceled)

12. (canceled)
